(19) United States
(12) Patent Application Publication
(10) Pub. No.: US 2006/0036565 A1
(43) Pub. Date: Feb. 16, 2006

(54) Passive monitoring of user interaction with a browser application

(76) Inventor: Carl Bruecken, Leesburg, VA (US)

Correspondence Address: FISH & RICHARDSON P.C., P.O. BOX 1022, MINNEAPOLIS, MN, 55440-1022, US

(21) Appl. No.: 10/914,075

(22) Filed: Aug. 10, 2004

(51) Int. Cl. G06F 17/30

(52) U.S. Cl. 707/1

(57) ABSTRACT

Assessing a user's interest level with respect to an electronic search result through passive monitoring of user interaction with a browser application includes determining that a user has requested an electronic search and enabling the user to perceive one or more identifiers. Each identifier corresponds to an electronic search result produced in response to the electronic search request. The user selects one of the identifiers and perceives the electronic search result corresponding to the selected identifier through a browser application. An interest level with respect to the electronic search result corresponding to the selected identifier is determined by passively monitoring the user's interactions with the browser application while the user perceives the electronic search result corresponding to the selected identifier.

### TECHNICAL FIELD

This document relates to electronic search services.

### BACKGROUND

One use of databases is to provide relevant information in response to user queries. Recently, the amount of available information has exploded due primarily to the expansion of the Internet and the World Wide Web. The World Wide Web may be viewed as a vast repository of information that offers a tremendous variety of general and special purpose search engines and information retrieval systems. Consequently, the challenges associated with finding the right databases and the right way to query them to achieve results of interest to the user are increasing as the World Wide Web and the Internet continue to grow.

### SUMMARY

In one general aspect, assessing a user's interest level with respect to an electronic search result through passive monitoring of user interaction with a browser application includes determining that a user has requested an electronic search and enabling the user to perceive one or more identifiers. Each identifier corresponds to an electronic search result produced in response to the electronic search request. The user selects one of the identifiers and perceives the electronic search result corresponding to the selected identifier through a browser application. An interest level with respect to the electronic search result corresponding to the selected identifier is determined by passively monitoring the user's interactions with the browser application while the user perceives the electronic search result corresponding to the selected identifier.

Implementations may include one or more of the following features. For example, determining that a user has requested an electronic search may include monitoring an address field associated with contents displayed by the browser application. Monitoring the address field may include monitoring the address field to determine whether the address in the address field corresponds to a search service provider. Determining that a user has requested an electronic search may include monitoring requests for information delivered by the browser application in response to user manipulation. Monitoring requests for information may include monitoring requests for information to determine whether the requests for information include a request for a search delivered to a search service provider.

Enabling the user to perceive one or more identifiers may include enabling the user to perceive a group of one or more hyperlinks selectable by the user to access electronic search results.

The browser application may be a specialized program to display, access, and process information. The information may be Internet content.

Determining an interest level with respect to the electronic search result may include monitoring the user interactions with the browser application to render, process, and access content without requiring active user input related to monitoring. Determining an interest level may include passively monitoring the user selecting to send content displayed by the browser application in an e-mail message or in an instant message, highlighting or copying text displayed by the browser application, saving an image displayed by the browser application, selecting one or more links displayed by the browser application, and selecting to bookmark an address associated with the electronic search result. Determining an interest level may include passively monitoring the direction and rate of scrolling by the user when using scroll bars in a user interface of the browser application. Determining an interest level may include passively monitoring the user bringing a user interface of the browser application into focus. The user interface may be a window and bringing the user interface into focus may include selecting the user interface so that the user interface window is placed on top of all other windows in a visually displayed desktop.

Enabling the user to perceive an electronic search result may include the user perceiving the electronic search result in an electronic search result display and determining an interest level with respect to the electronic search result may include passively monitoring the user returning to perceive the electronic search result display after perceiving a display presented in response to selection of a link included in the electronic search result display.

Determining an interest level with respect to the electronic search result may include assigning a weighting factor to each type of passively monitored user interaction, determining an interest value indicative of the level of user interaction with respect to each type of user interaction, using the weighting factors to weight the corresponding determined interest values for each type of user interaction, and combining the weighted interest values to arrive at an aggregate interest level number. Higher weighting factors may be assigned to types of user interactions deemed to correspond to greater user interest in the electronic search result.

In another general aspect, assessing the effectiveness of an electronic search through passive monitoring of user interaction with a browser application includes determining that a user has requested an electronic search and enabling the user to perceive through a browser application a display of one or more identifiers. Each identifier corresponds to an electronic search result produced in response to the electronic search request. The effectiveness of the requested electronic search is determined by passively monitoring the user's interactions with the browser application while the user perceives content related to the electronic search.

Implementations may include one or more of the following features. For example, the content related to the electronic search may include content in the display and content related to the electronic search results.

Determining the effectiveness of the electronic search may include enabling the user to select one or more of the identifiers and enabling the user to perceive the electronic search results corresponding to the selected one or more identifiers through a browser application. Interest levels with respect to the electronic search results corresponding to the selected one or more identifiers are determined by passively monitoring the user's interactions with the browser application while the user perceives the one or more electronic search results. The effectiveness of the search is determined based on the determined search result interest levels. Determining the effectiveness of the electronic search also may include determining an interest level with respect to the search by passively monitoring the user's interactions with the browser application while the user perceives the display. The effectiveness of the search is determined based on the determined search interest level and search result interest levels. Determining the effectiveness of the search based on the determined search interest level and search result interest levels may include assigning weighting factors to the search and search result interest levels, using the factors to weight the interest levels, and combining the weighted interest levels to arrive at a search effectiveness rating. Higher weighting factors may be assigned to search result interest levels corresponding to search results placed higher in a list of search results presented in the display.

The details of one or more implementations are set forth in the accompanying drawings and the description below. Other features will be apparent from the description and drawings, and from the claims.

### DESCRIPTION OF DRAWINGS

FIGS. 1 and 2 are block diagrams of communications systems for delivering and exchanging data between a client system, a host system with passive monitoring capability, and a host system with search service capability.

FIG. 3 is a flowchart illustrating a process for assessing the effectiveness of an electronic search through passive monitoring of user interactions with a browser application.

FIG. 4 is a user interface of a browser application.

FIG. 5 is a user interface of a browser application including a search result list display.

FIG. 6 is a user interface of a browser application including a search result display.

FIGS. 7 and 8 are flowcharts illustrating processes for assessing the effectiveness of an electronic search through passive monitoring of user interactions with a browser application.

FIG. 9 illustrates a diagram of a data structure for storage of search interest level and search effectiveness information.

FIG. 10 illustrates a graph of rate of scrolling data collected by the browser application.

FIG. 11 illustrates a graph of in-focus/out-of-focus data collected by the browser application.

FIG. 12 is a user interface of a browser application including additional search-related buttons.

Like reference symbols in the various drawings indicate like elements.

### DETAILED DESCRIPTION

A browser application may be modified to passively monitor user interactions with the browser application while the user is accessing and perceiving content across a network. The user interactions with the browser application may include, but are not limited to, the user selecting to send displayed content in an e-mail or instant message, the user highlighting or copying text in the displayed content, the user saving an image in the displayed content, the direction and rate of scrolling initiated by the user when using scroll bars in the user interface of the browser application to perceive content, and the user selecting a link in the displayed content. These and other user interactions with the browser application may be processed to determine interest levels with respect to contents viewed by the user when using the browser application. The determined interest levels may be used to assess the effectiveness of an electronic search and may be provided to search service providers to enable the search service providers to improve the effectiveness of their search services. Furthermore, the determined interest levels may be used by the browser application to enable the user to identify and return to sites containing contents of interest and to identify and re-request past electronic searches.

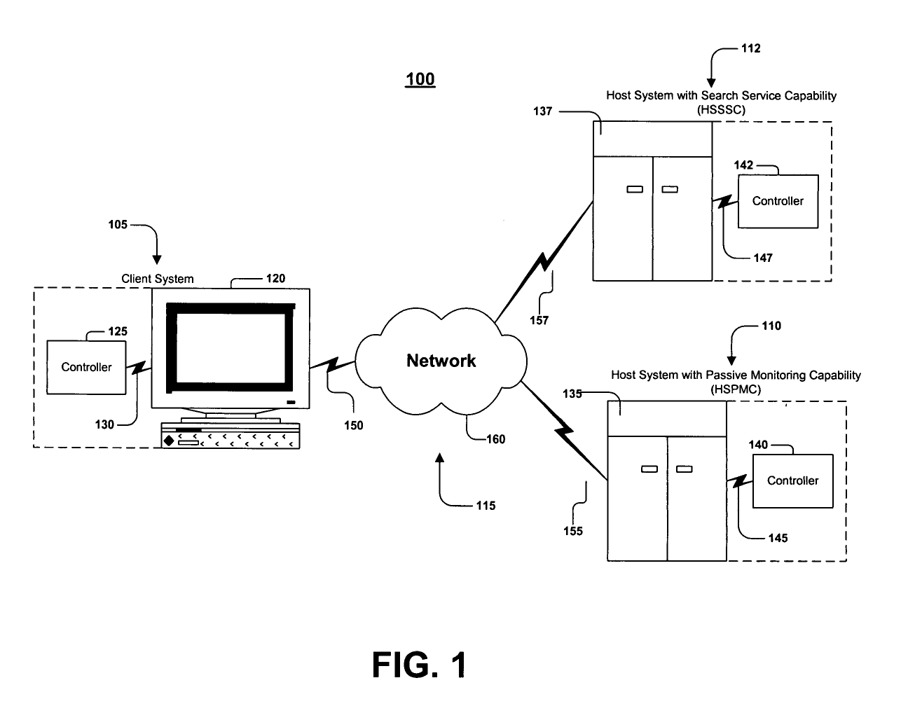

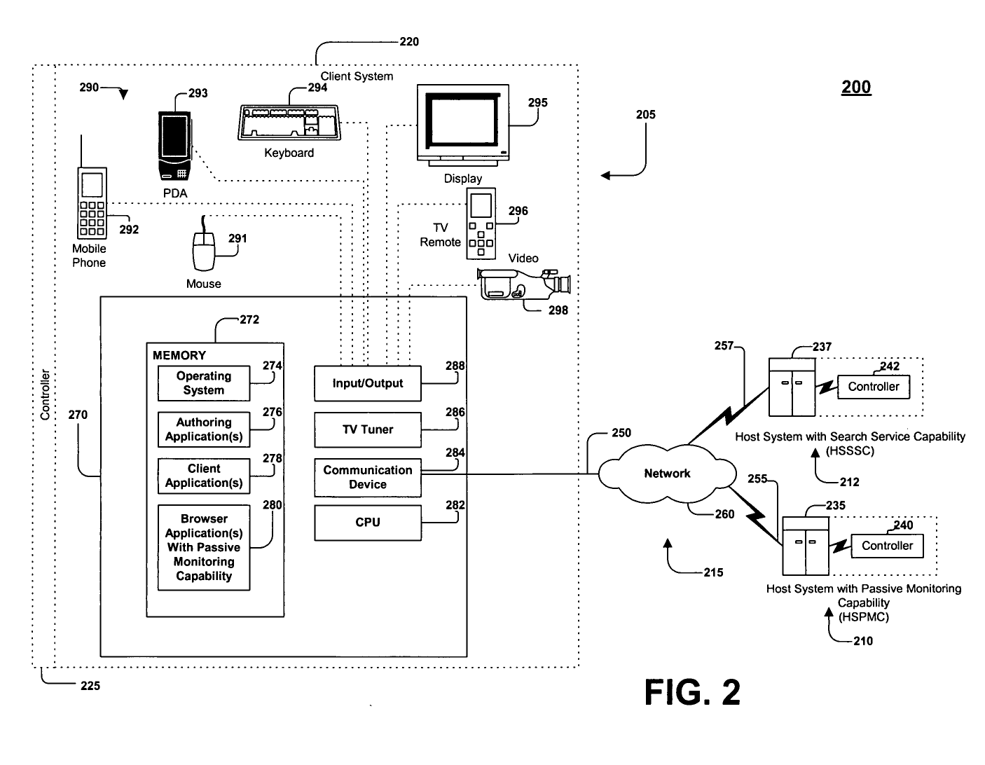

For illustrative purposes, FIGS. 1 and 2 describe communications systems for implementing techniques for assessing the effectiveness of an electronic search through passive monitoring of user interaction with a browser application. For brevity, several elements in the figures described below are represented as monolithic entities. However, as would be understood by one skilled in the art, these elements each may include numerous interconnected computers and components designed to perform a set of specified operations and/or dedicated to a particular geographical region.

Referring to FIG. 1, a communications system 100 is capable of delivering and exchanging data between a client system 105, a host system with passive monitoring capability (HSPMC) 110, and a host system with search service capability (HSSSC) 112 through a communications link 115. The client system 105 typically includes one or more client devices 120 and/or client controllers 125, and the HSPMC 110 and HSSSC 1112 typically include, respectively, one or more host devices 135 or 137 and/or host controllers 140 or 142. For example, the client system 105, the HSPMC 110, or the HSSSC 112 may include one or more general-purpose computers (e.g., personal computers), one or more special-purpose computers (e.g., devices specifically programmed to communicate with each other and/or the client system 105, the HSPMC 110, or the HSSSC 112), or a combination of one or more general-purpose computers and one or more special-purpose computers. The client system 105, the HSPMC 110, and the HSSSC 112 may be arranged to operate within or in concert with one or more other systems, such as, for example, one or more LANs (“Local Area Networks”) and/or one or more WANs (“Wide Area Networks”).

The client device 120 (or the host device 135 or 137) is generally capable of executing instructions under the command of a client controller 125 (or a host controller 140 or 142), and is connected to the client controller 125 (or the host controller 140 or 142) by a wired or wireless data pathway 130 (or 145 or 147) capable of delivering data.

Each of the client device 120, the client controller 125, the host devices 135 and 137, and the host controllers 140 and 142 typically includes one or more hardware components and/or software components. An example of a client device 120 or a host device 135 or 137 is a general-purpose computer (e.g., a personal computer) capable of responding to and executing instructions in a defined manner. Other examples include a special-purpose computer, a workstation, a server, a device, a component, other physical or virtual equipment or some combination thereof capable of responding to and executing instructions.

An example of client controller 125 or a host controller 140 or 142 is a software application loaded on the client device 120 or the host device 135 or 137 for commanding and directing communications enabled by the client device 120 or the host device 135 or 137. Other examples include a program, a piece of code, an instruction, a device, a computer, a computer system, or a combination thereof, for independently or collectively instructing the client device 120 or the host device 135 or 137 to interact and operate as described. The client controller 125 and the host controller 140 or 142 may be embodied permanently or temporarily in any type of machine, component, physical or virtual equipment, storage medium, or propagated signal capable of providing instructions to the client device 120 or the host device 135 or 137.

The communications link 115 typically includes a delivery network 160 that supports direct or indirect communication between the client system 105, the HSPMC 110, and the HSSSC 112, irrespective of physical separation. Examples of a delivery network 160 include the Internet, the World Wide Web, WANs, LANs, analog or digital wired and wireless telephone networks (e.g., PSTN, ISDN, and xDSL), radio, television, cable, satellite, and/or any other delivery mechanism for carrying data. The communications link 115 also includes communication pathways 150, 155, and 157 that enable communications through the one or more delivery networks 160 described above. Each of the communication pathways 150, 155, and 157 may include, for example, a wired, wireless, cable or satellite communication pathway.

FIG. 2 illustrates a communication system 200 including a client system 205 communicating with HSPMC 210 and with HSSSC 212 through a communications link 215. Client system 205 typically includes one or more client devices 220 and one or more client controllers 225 for controlling the client devices 220. HSPMC 210 and HSSSC 212 typically include, respectively, one or more host devices 235 or 237 and one or more host controllers 240 or 242 for controlling the one or more host devices 235 or 237. The communications link 215 includes communication pathways 250, 255 and 257 that enable communications through a delivery network 260.

Examples of each element within the communication system of FIG. 2 are broadly described above with respect to FIG. 1. In particular, the HSPMC 210, the HSSSC212, and the communications link 215 typically have attributes comparable to those described with respect to the HSPMC 110, the HSSSC 112, and the communications link 115 of FIG. 1, respectively. Likewise, the client system 205 of FIG. 2 typically has attributes comparable to, and may illustrate one possible implementation of, the client system 105 of FIG. 1.

The client device 220 typically includes a general purpose computer 270 having an internal or external storage 272 for storing data and programs such as an operating system 274 (e.g., DOS, Windows®, Windows® 95, Windows® 98, Windows® 2000, Windows® NT, Windows® Millennium Edition, Windows® XP, OS/2, and Linux) and one or more application programs. Examples of application programs include authoring applications 276 (e.g., word processing, database programs, spreadsheet programs, presentation programs, and graphics programs) capable of generating documents or other electronic content; client applications 278 (e.g., AOL client, CompuServe client, AIM client, AOL TV client, and ISP client) capable of communicating with other computer users, accessing various computer resources, and viewing, creating, or otherwise manipulating electronic content; and a browser application 280.

The browser application 280 may be a conventional browser that renders Internet content or, more generally, a specialized program used to display, access, and process information. The browser application 280 is modified to passively monitor user interactions with the browser application 280 when viewing displayed content. In one implementation, the browser application 280 is able to request one or more Web pages to be downloaded from the HSPMC 210, the HSSSC 212, or from another host system. The browser application 280 may use, for example, Hypertext Transfer Protocol (HTTP) to communicate through the communications link 215 with the HSPMC 210 or other host system. Once a Web page is downloaded, the browser 280 processes the Web page and may display information described in a Web page file associated with the Web page. The browser application 280 may, for example, use Hypertext Markup Language (HTML) or Extensible Markup Language (XML) in processing the Web page. The browser application 280 also may be configured to process Java files and programs such as applets.

The general-purpose computer 270 also includes a central processing unit 282 (CPU) for executing instructions in response to commands from the client controller 225. In one implementation, the client controller 225 includes one or more of the application programs installed on the internal or external storage 272 of the general-purpose computer 270. In another implementation, the client controller 225 includes application programs externally stored in and executed by one or more device(s) external to the general-purpose computer 270.

The general-purpose computer typically also includes a communication device 284 for sending and receiving data. One example of the communication device 284 is a modem. Other examples include a transceiver, a set-top box, a communication card, a satellite dish, an antenna, or another network adapter capable of transmitting and receiving data over the communications link 215 through a wired or wireless data pathway 250. The general-purpose computer 270 also may include a TV tuner 286 for receiving television programming in the form of broadcast, satellite, and/or cable TV signals. As a result, the client device 220 can selectively and/or simultaneously display network content received by communications device 284 and television programming content received by the TV tuner 286.

The general-purpose computer 270 also includes an input/output interface 288 to enable a wired or wireless connection to various peripheral devices 290. Examples of peripheral devices 290 include, but are not limited to, a mouse 291, a mobile phone 292, a personal digital assistant 293 (PDA), a keyboard 294, a display monitor 295 with or without a touch screen input, and/or a TV remote control 296 for receiving information from and rendering information to subscribers. Other examples may include voice recognition and synthesis devices.

Although FIG. 2 illustrates devices such as the mobile telephone 292, the PDA 293, and the TV remote control 296 as being peripheral with respect to the general-purpose computer 270, in another implementation, such devices may themselves include the functionality of the general-purpose computer 270 and operate as the client device 220. For example, the mobile phone 292 or the PDA 293 may include computing and networking capabilities, and may function as a client device 220 by accessing the delivery network 260 and communicating with the host system 210. Furthermore, the client system 205 may include one, some, all, or none of the components and devices described above.

The HSPMC 210 is a host system that communicates with the client system 205 to passively monitor user interactions with the browser application 280. The HSPMC 210 periodically receives user interaction data from the browser application 280. The HSPMC 210 processes the user interaction data to determine the effectiveness of an electronic search requested by the user of the client system 205, and to determine a user's interest level with respect to a particular electronic search result. The electronic search is initiated by the user through the browser application 280 and is typically a keyword search submitted by the browser application 280 to the HSSSC 212. The HSPMC 210 may send interest level and search result effectiveness information to the client system 205, the HSSSC 212, or to another system that requests this information.

The HSSSC 212 is a host system that offers search services to the client system 205. The HSSSC 212 includes a search engine capable of generating a group of search results in response to a search request submitted by a user through use of the browser application 280. Examples of HSSSC 212 include, for example, YAHOO® and GOOGLE®.

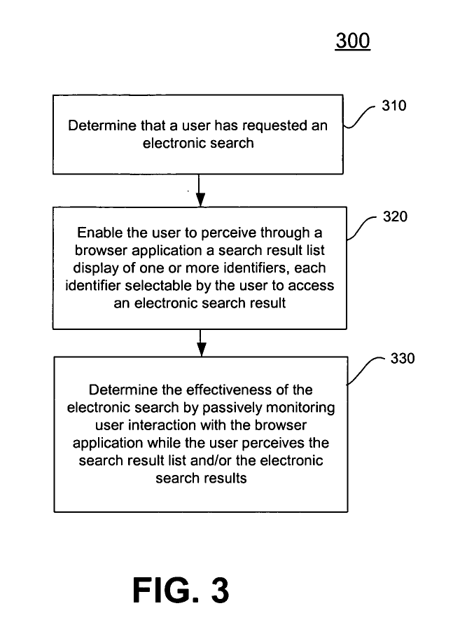

Referring to FIG. 3 and using the system of FIG. 2 as an example, a process 300 for assessing the effectiveness of an electronic search through passive monitoring of user interactions with a browser application includes determining that a user of the client system of 205 has requested an electronic search (310). Typically, the user requests the electronic search through use of the browser application 280. The browser application 280 may be configured to monitor the user's requests for information. For example, the browser application 280 may be configured to monitor the HTTP requests submitted by the user to determine whether a HTTP request corresponds to a search request sent to the HSSSC 212 (i.e., a host system recognized as offering search services). Alternatively, the browser application 280 may determine that a user has requested an electronic search by monitoring user input in response to content displayed that is recognized as corresponding to the address of the HSSSC 212 (e.g., the user inputs the search terms “Everquest guild” in a search term field and selects to execute a search in a Web page corresponding to the address of www.sornsearchengine.com, a known host system that offers search services).

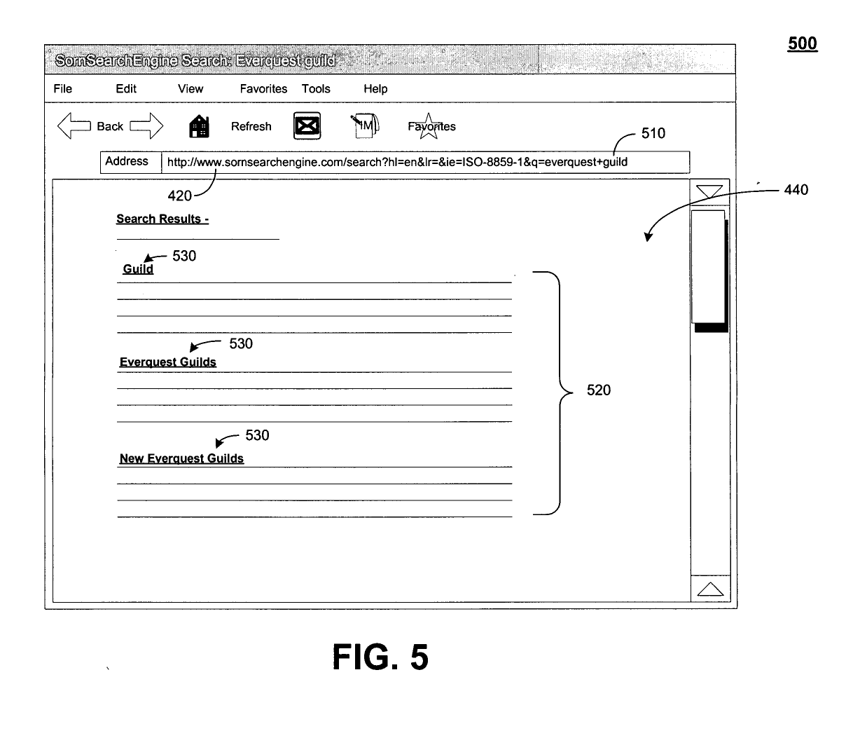

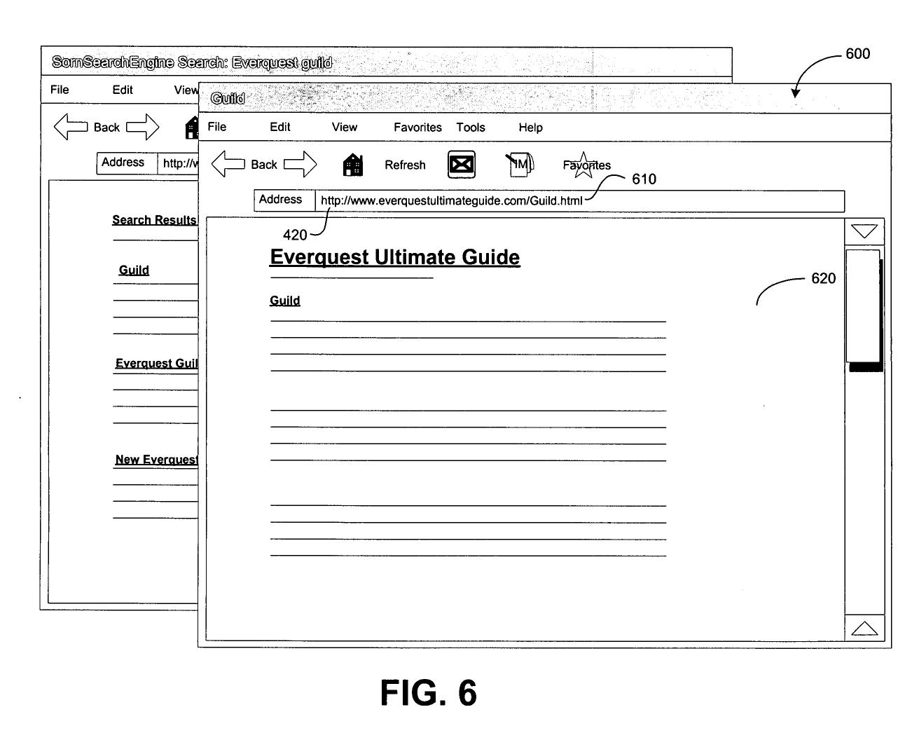

The browser application 280 receives content from the HSSSC 212 in response to the search request and enables the user to perceive the received content in a search result list display (320). Typically, the search result list display includes a display of one or more identifiers that are each selectable by the user to access an electronic search result. When the user selects one of the identifiers using, for example, a peripheral device 290, the browser application 280 accesses the corresponding electronic search result and displays the content associated with the electronic search result in an electronic search result display. An implementation example of a search result list display is discussed below with reference to FIG. 5. An implementation example of a search result display is discussed below with reference to FIG. 6.

The effectiveness of the electronic search may then be determined by passively monitoring user interactions with the browser application 280 while the user perceives the search result list display and/or search result displays (330). Passive monitoring of user interactions with the browser application 280 is generally defined as monitoring how the user uses the browser application 280 to render, process, and/or access content without requiring active user input related to monitoring.

The user interactions with the browser application 280 that may be passively monitored include, but are not limited to, (1) the user selecting to send displayed content in an e-mail or in an instant message; (2) the user highlighting or copying text displayed in a search result list or search result display; (3) the user saving an image displayed in a search result list or search result display; (4) the direction and rate of scrolling by the user when using scroll bars in the browser application user interface to view a search result list or search result display; (5) the user selecting one or more displayed links in a search result list or search result display; (6) the user bringing a search result list or search result display into and out of focus (e.g., selecting a search result list window or search result window so that it is placed on top of all other windows in a visually displayed desktop is equivalent to bringing it into focus); (7) the user selecting to bookmark or otherwise save the address associated with the displayed content in a search result list display or search result display; and (8) the user returning to a search result list display or search result display after viewing another display arrived at by selecting a link in the search result list display or search result display.

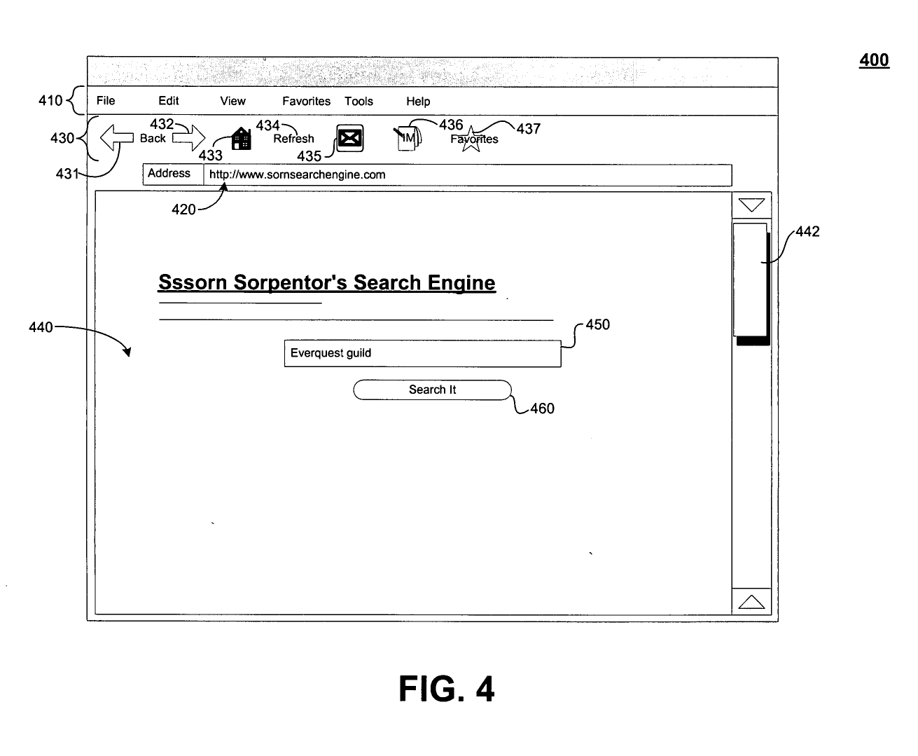

FIG. 4 illustrates an example of a browser user interface 400 that may be used to request a search. The browser user interface 400 includes a menu bar 410, an address field 420, a button bar 430, and a content display section or window 440. The menu bar 410 may include various drop-down menus, such as, for example, file, edit, view, favorites, tools, and help. The drop-down menus may include functions that implement or modify the display or communication parameters of the browser application. The browser application 280 may passively monitor user selection of any of the functions available through the menu bar 410.

The address field 420 displays the address that corresponds to the content that is currently displayed in the window 440 and that corresponds to the latest information or content request sent by the browser application 280. In particular, the address in the address field 420 may be the address that was used to access a host system to retrieve the content displayed in the window 440. For example, the address in the address field 420 may be a domain name address which may be converted to one or more Internet Protocol addresses. In this example, the content displayed corresponds to an address or domain name “sornsearchengine.com” of a host system that offers search services. The user may interact with the displayed content to request an electronic search. The electronic search requested by the user in FIG. 4 includes the search terms “Everquest guild.” The browser application 280, for example, may determine that the user is requesting an electronic search by determining that the user is responding to content displayed in the window 440 that corresponds to a recognized address of the HSSSC 212 services (i.e., the address or domain name “searchengine.com” corresponds to a recognized search engine). Alternatively, the browser application 280 may monitor all information requests (e.g., HTTP requests) sent by the browser application 280 as discussed above to identify an information request that corresponds to an electronic search request.

The button bar 430 may include a number of buttons. The buttons may be shortcuts to functions in the drop-down menus that are used frequently and that activate tools used to request and display content. The button bar 430 includes a stack arrow back button 431, a stack arrow forward button 432, a home button 433, a refresh button 434, a send e-mail button 435, an instant message button 436, and a favorites button 437. The browser application may passively monitor user selection of any of the buttons in the button bar 430.

The stack arrow back button 431 and the stack arrow forward button 432 may be selected by the user to move up and down the stack of addresses recently accessed by the user and to display the corresponding content in the window 440. Moving up and down a stack of previously accessed addresses through selection of icons in a tool bar is a known feature in browser applications such as, for example, MICROSOFT INTERNET EXPLORER and NETSCAPE NAVIGATOR.

The home button 433 may be selected by the user to access and perceive content associated with a predetermined address specified by or for the user and designated by or for the user as the user's “Home” content display (e.g., his or her “Home” Web page). The refresh button 434 may be selected by the user to instruct the host system corresponding to the address in the address field 420 to refresh or update the content associated with the address in the address field 420, all or part of which is displayed in the window 440.

The send e-mail button 435 and the instant message button 436 may be selected by the user to send all or a portion of the content associated with the address in the address field 420 or a link to all or a portion of that content to another user or entity in an e-mail or instant message, respectively. The user is typically prompted to input an e-mail address or an instant message address corresponding to the recipient(s) prior to sending the link or content.

The favorites button 437 may be selected by the user to access, add, remove, and organize a list of favorite or bookmarked addresses that correspond to displayable content that is of particular interest to the user. The user may select the favorites button 435 to, for example, add or bookmark the address in the address field 420 to the user's list of favorite or bookmarked addresses. The user may then select the favorite or bookmarked address at a later date to instruct the browser to automatically submit an information request to the host system corresponding to that address.

The content display section or window 440 is configured to display the content associated with the address in the address field 420. The window 440 may include horizontal or vertical scroll bars 442 or other means that allow the window to be sized to fit on different displays while providing access to content elements that may extend beyond the window. The user may click on or otherwise select the scroll bars 442 to traverse through the content associated with the address in the address field 420 such that different portions of the content are displayed at a given time in the window 440. The window 440 may display content corresponding, for example, to code written in a markup language, such as HTML, SGML, DHTML, XML, or XHTML, that was interpreted and processed for display by the browser application 280.

The user also may interact with the window 440 by, for example, highlighting or copying text displayed in the window 440, selecting an image displayed in the window 440 and saving that image in a local or remote data store in the client system 205 or accessible to the client system 205, and selecting a link displayed in the window 440 that corresponds to another address and that, when selected, instructs the browser application 280 to access, render, and display content associated with that address in the window 440 or, alternatively, in a new window or interface. The browser application may be configured to passively monitor user selection of the scroll bar 442 and other user interactions with the window 440 including, but not limited to, those discussed above.

In the example of FIG. 4, the window 440 includes a display of content that enables a user to request an electronic search from a search service. The user may input search terms (e.g., “Everquest guild”) by typing into the search term field box 450 and may request the search by selecting the graphical icon 460 labeled “Search it.” Upon inputting the search terms and selecting the icon 460, the browser application 280 submits an electronic search request to the host system corresponding to the address in the address field 420 (e.g., “sornsearchengine.com”).

FIG. 5 illustrates an example of a browser user interface 500 including a search result list display. For the purposes of this discussion, the “search result list display” is a display of any identifiers corresponding to electronic search results that were identified by the HSSSC 212 in response to an electronic search request submitted by the client system 205. The HSSSC 212 may provide the electronic search results to the client system 205 in multiple subgroupings (e.g., 100 search results may be divided up into four subgroupings: 1-25, 26-50, 51-75, and 76-100), with each subgrouping sent in one transmission and each subsequent subgrouping sent in response to a user request or otherwise (e.g., the user may select a link in the window 440 that requests the next subgrouping).

The browser user interface 500 corresponds to the user interface 400 with the exception that the address field 420 now shows an address 510 associated with a search request submitted to the HSSSC 212, and the window 440 now displays content that includes a list or grouping 520 of one or more search result identifiers 530. Each search result identifier 530 may be selected to access or retrieve a corresponding electronic search result. For example, the identifiers 530 may be embedded hyperlinks selectable by the user to access a host system to retrieve the content associated with that electronic search result. The browser application 280 may determine that the user is interacting with a search result list display by monitoring the address field 510 or by monitoring the user's requests for information (e.g., HTTP requests).

FIG. 6 illustrates an example of a browser user interface 600 including a search result display. For the purposes of this discussion, the “search result display” is a display of the content retrieved upon selection of a search result identifier in the search result list display. The search result list display and the search result display share a parent-child relationship in that selection of a search result identifier or link 530 in the search result list display “spawns” or enables the user to perceive the search result display. Similarly, selection of an identifier or link in the search result display may “spawn” or enable the user to perceive a “search result child display” that shares a grandparent-grandchild relationship with the search result list display. Taking this further, selection of an identifier or link in a search result child display may “spawn” or enable the user to perceive a “search result grandchild display” that shares a great grandparent-great grandchild relationship with the search result list display. In one implementation, the browser application 280 passively monitors user interactions with the search result list display and the search result displays and does not passively monitor user interactions with the search result child or search result grandchild displays.

The browser user interface 600 corresponds to the user interface 400 with the exception that the address field 420 now shows an address 610 that was used to retrieve an electronic search result from a host system. The window 440 now displays content 620 that corresponds to an identifier 530 selected from the search result list display. The browser application 280 may determine that the user is interacting with a search result display by monitoring selection of the identifier 530 in the search result list display and monitoring the address field 610. Additionally or alternatively, the browser application 280 may determine that the user is interacting with a search result display by monitoring the user's requests for information (e.g., HTTP requests).

As shown in FIG. 6, the browser application 280 may be configured to generate a new window that displays the browser user interface 600 upon selection of the identifier 530. The new window may be displayed over the window displaying the browser user interface 500. Alternatively, the window displaying the browser user interface 500 may be updated to display the browser user interface 600 upon selection of the identifier 530. If the browser application 280 is configured to display multiple windows, the user may bring a window to the top of the stack of displayed windows (i.e., bring the window “into focus”) by, for example, selecting or otherwise accessing the window.

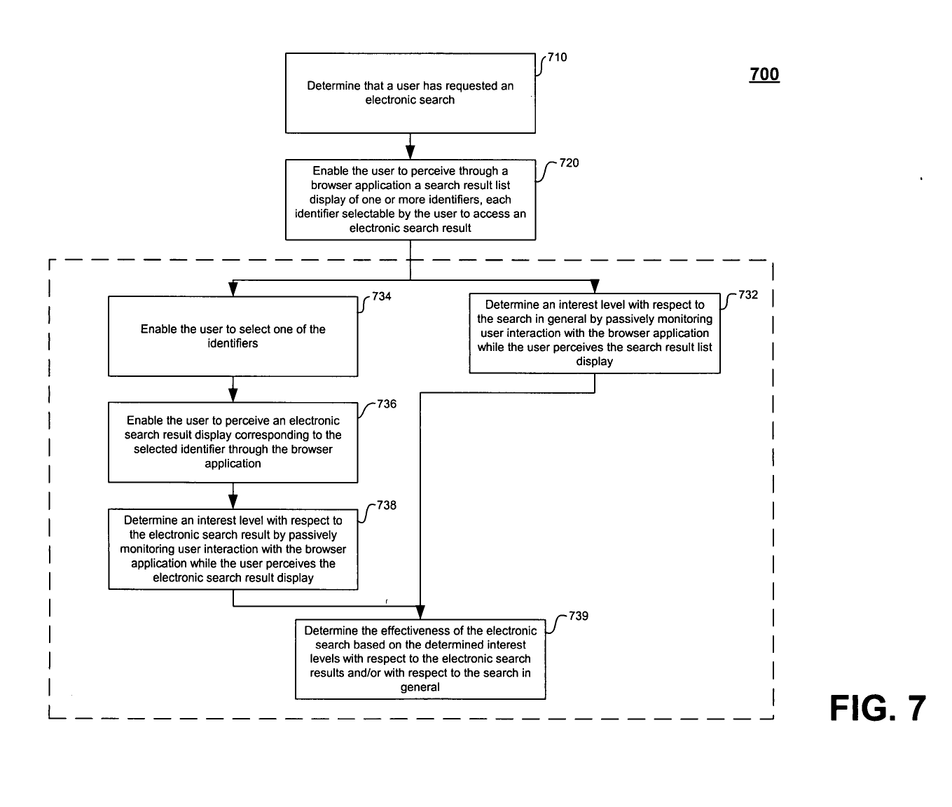

FIG. 7 illustrates a particular implementation 700 of the process 300 for assessing the effectiveness of an electronic search through passive monitoring of user interactions with a browser application. The method 700 includes determining that a user of the client system 205 has requested an electronic search (710). The browser application 280 receives content from the HSSSC 212 in response to the electronic search request and enables the user to perceive the received content in a search result list display (720). These operations may be performed in the same manner as discussed above in reference to operations 310 and 320 of FIG. 3.

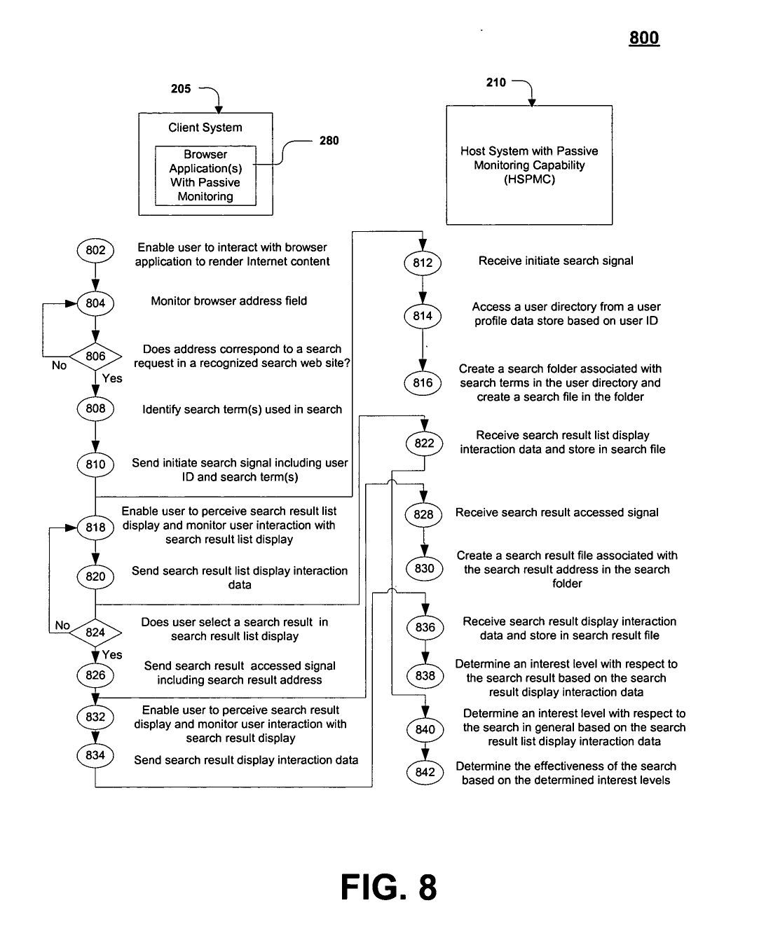

The user's interactions with the browser application 280 when perceiving the search result list display are passively monitored and an interest level with respect to the search in general is determined based on the interactions (732). An interest level may be determined by, for example, assigning an interest level weight to each type of passively tracked user interaction (e.g., to each of the eight types of interaction mentioned with respect to operation 330 of FIG. 3), multiplying the interest level weight with a value indicative of the level of user interaction with respect to that type of interaction, and adding the results to arrive at an aggregate interest level number. Implementation details related to this approach to interest level determination are discussed below with respect to FIGS. 8-10.

The user may select an identifier 530 in the search result list display (734). The browser application 280 receives content from a host system in response to selection of the identifier 530 and enables the user to perceive a corresponding search result display (736). The user's interactions with the browser application 280 when perceiving the search result display are passively monitored and an interest level with respect to that electronic search result is determined based on the interactions (738). The interest level may be determined in the same manner as described above with respect to operation 732.

An effectiveness of the search may then be determined based on the determined interest levels with respect to the electronic search results and/or with respect to the search in general (739). The effectiveness of the search may be reflected in a number calculated, for example, by adding the determined interest level with respect to the search in general and the determined interest levels with respect to the electronic search results. The interest levels may be multiplied by a weighing factor prior to performing the addition. For example, the weighing factor for an interest level corresponding to an electronic search result that is lower in the search result list may be less than the weighing factor for an interest level that is higher in the search result list.

FIG. 8 shows a process 800 for assessing the effectiveness of an electronic search through passive monitoring of user interactions with a browser application. For convenience, particular components described with respect to FIG. 2 are referenced as performing the process 800. However, similar methodologies may be applied in other implementations where different components are used to define the structure of the system or where the functionality is distributed differently among the components shown in FIG. 2. While process 800 shows various operations performed by the HSPMC 210, some or all of these operations may be performed by the browser application 280 of the client system 205.

The user of the client system 205 interacts with the browser application 280 to render Internet content (802). The browser application 280 monitors the address field 420 (804). The browser application 280 determines whether the address in the address field 420 corresponds to an address of a recognized host system that offers search services (e.g., HSSSC 112, 212) (806). If the address in the address field 420 does not correspond to the address of a recognized host system that offers search services, the browser application 280 continues to monitor the address field 420 (804). If the address in the address field 420 corresponds to the address of a recognized host system that offers search services, the browser application 280 identifies the search terms or keywords submitted with the search request or included in the address field 420 (808).

The browser application 280 sends an initiate search signal to the HSPMC 210 (810). The initiate search signal includes a user identity and the identified search terms or keywords associated with the search request. The user identity, for example, may be the identity submitted by the user of the client system 205 when logging into the HSPMC 210.

The HSPMC 210 receives the initiate search signal and accesses a portion of a user profile data store (not shown) allocated to the user identity (i.e., accesses a user folder for that user identity) (814). The HSPMC 210 creates a search folder (or otherwise allocates a portion of the user folder) to store user interaction data related to the search (816). The search folder is associated with the search terms or keywords of the search request (e.g., the name of the folder may include the search terms). The search folder may include an entry indicating the search engine or search service used to perform the search.

The browser application 280 enables the user to perceive a search result list display and monitors the user interaction with the search result list display (818). The browser application 280 periodically sends search result list display interaction data to the HSPMC 210 (820). The HSPMC 210 receives the search result list display interaction data and stores the data in a search file in the search folder (822). The search file is associated with the search terms of keywords of the search request (e.g., the name of the file may include the search terms) and, for example, may be a text (.txt) file or comma separated variable (.csv) file.

The search result list display interaction data is data associated with user interactions with the browser application 280 while the user perceives the search result list display (i.e., while the search result list display is in focus). The search result list display interaction data may be sent to the HSPMC 210 when a user interaction event occurs or, additionally or alternatively, when the search result list display and all of the search result displays associated with the search are closed or otherwise no longer perceivable by the user (e.g., the user exits from the browser application 280). The user interaction data is discussed in more detail below.

The browser application 280 determines whether the user has selected an identifier 530 corresponding to an electronic search result in the search result list display (824). The browser application sends a “search result accessed” signal to the HSPMC 210 (826). The search result accessed signal includes the search result address corresponding the electronic search result.

The HSPMC 210 receives the search result accessed signal (828) and creates a search result file associated with the search result address in the search folder (830). The search result file may be associated with a search result address by, for example, including all or a portion of the search result address in the name of the search result file. The search result file, for example, may be a text (.txt) file or comma separated variable (.csv) file.

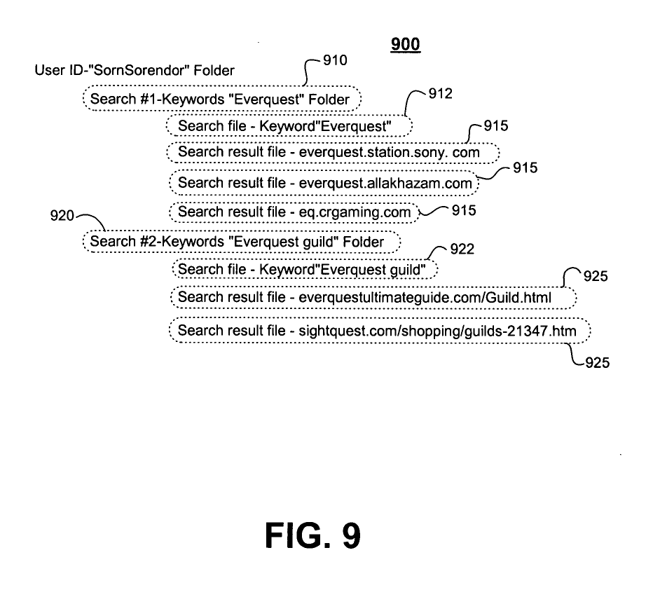

FIG. 9 shows an exemplary data structure 900 for storage of search interest level and effectiveness information. The data structure 900 includes a user folder corresponding to the identity “SornSorendor”. The user folder 900 includes two search folders 910 and 920. Each search folder includes a respective search file 912, or 922 that stores search result list display interaction data. The search folder 910 includes three search result files 915, indicating that the user accessed three search results (e.g., “everquest.station.sony.com”; “everquest.allakhazam.com”; and “eq.crgaming.com”) from the search result list corresponding to the term “Everquest.” The search folder 920 includes two search result files 925 indicating that the user accessed two search results (e.g., “everquestulitmateguide.com/guild.html” and “sightquest.com/shopping/guilds-21347.htm”) from the search result list corresponding to the terms “Everquest guild.” The data organization presented in the process 800 and in the data structure 900 is an exemplary implementation of a data organization that may be used to categorize and store the search-related data and, therefore, is not meant to be limiting. Other data organizations and data structures may be used.

Referring back to FIG. 8, the browser application 280 enables the user to perceive a search result display and monitors the user interaction with the search result display (832). The browser application 280 periodically sends search result display interaction data to the HSPMC 210 (834). The HSPMC 210 receives the search result display interaction data and stores the data in a search result file in the search folder (836).

The search result display interaction data is data associated with user interactions with the browser application 280 while the user perceives the search result display (i.e., the search result display is in focus). The search result display interaction data may be sent to the HSPMC 210 when a user interaction event occurs or, additionally or alternatively, when the search result list display and all of the search result displays associated with the search are closed or otherwise no longer perceivable by the user (e.g., the user exits from the browser application 280).

The user interaction data sent to the HSPMC 210 varies depending on the type of interaction monitored by the browser application 280. If the browser application 280 determines that a user has e-mailed or used instant messaging to send all or a portion of the contents of the search result list display, or a link to all or a portion of the contents of the search result list display or search result display, the browser application 280 may send an “e-mail/IM sent” signal to the HSPMC 210. In one implementation, the browser application 280 may determine that the user has sent an e-mail/IM by monitoring user selection of buttons 435 and 436. Upon receiving the e-mail/IM sent signal, the HSPMC 210 may update the search file or the corresponding search result file by setting a flag or other indicator to track that the user sent an IM and/or e-mail associated with the contents of the search result list display or search result display.

If the user highlights or copies text displayed in the search result list display or search result display, the browser application 280 may send user interaction data that includes the amount of characters highlighted/copied, the number of times that the user highlighted/copied text, and the size and number of contiguous blocks of text highlighted/copied. The browser application 280 may determine whether text is highlighted by monitoring user interaction with the window 440. In one implementation, the browser application may determine that text is copied by registering with the operating system 274 to receive an event signal when the user copies text. The HSPMC 210 may update the search file or the corresponding search result file to include this data.

If the user saves an image displayed in the search result list display or search result display, the browser application 280 may send an “image saved” signal to the HSPMC 210. In one implementation, the browser application 280 may determine that an image was saved by registering with the operating system 274 to receive an event signal when the user saves an image. The HSPMC 210 may update the search file or corresponding search result file by setting a flag or other indicator to track that the user saved an image associated with the contents of the search result list display or search result display.

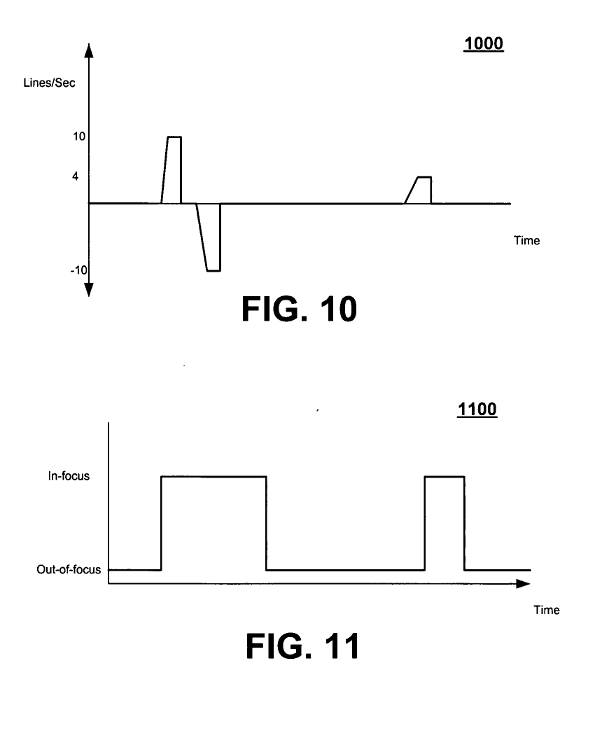

The direction and rate of scrolling by the user when using scroll bar 442 to view the contents in window 440 also may be monitored by the browser application 280. The rate of scrolling data collected by the browser application 280 may be graphed as shown in FIG. 10. The rate of scrolling data may include the rate of scrolling in lines per second (e.g., 4 lines/second) over time. The direction of scrolling may be indicated by the polarity of the rate of scrolling. For example, scrolling down the screen may be indicated by a positive rate of scrolling (e.g., +4 lines/second) and scrolling up the screen may be indicated by a negative rate of scrolling (e.g., −4 lines/second). The browser application 280 may monitor and collect the rate of scrolling data as the user perceives the search result list display and the search result displays. The browser application 280 may compress this data and send it to the HSPMC 210 in one transmission or, alternatively, in multiple transmissions over time. The HSPMC 210 updates the search file or corresponding search result file to include the rate of scrolling data.

If the user selects a link displayed in the search result list display or search result display, the browser application 280 may send a “link selected” signal to the HSPMC 210. The link selected signal may include the address embedded in the link. The browser application 280 may determine that a link was selected by monitoring user interaction with the window 440. The HSPMC 210 may update the search file or corresponding search result file by storing the address embedded in the link and incrementing a counter that tracks the number of times a link was selected in the display.

The browser application 280 also may monitor when the user brings a search result list display window or a search result display window into and out of focus. The in-focus/out-of-focus data collected by the browser application 280 may be graphed as shown in FIG. 11. The data may include intervals of time when the search result list window or search result display window is in-focus and intervals of time when the search result list window or search result display window is out-of-focus. In one implementation, the browser application 280 may determine that a window has been brought into focus by registering with the operating system 274 to receive an in-focus event signal when the user brings the window into focus. The browser application 280 may send this in-focus/out-of-focus data to the HSPMC 210 in one transmission or, alternatively, in multiple transmissions over time. The HSPMC 210 updates the search file or corresponding search result file to include the in-focus/out-of-focus data.

If the user selects to bookmark or add the address of the search result list display (e.g., address 510) or search result display (e.g., address 610) to a favorites list, the browser application 280 may send a “bookmarked address” signal to the HSPMC 210. The bookmarked address signal may include the address bookmarked or added to the favorites list. In one implementation, the browser application 280 may determine that an address was bookmarked by monitoring user interaction with the favorites button 437. The HSPMC 210 may update the search file or corresponding search result file by setting a flag or other indicator to track that the user bookmarked the address corresponding to the search result list display or search result display.

If the user returns to a search result list display or search result display (i.e., a parent display) after viewing another display (i.e., a child display) arrived at by selecting a link in the search result list display or search result display, the browser application 280 may send a “returned-to-display” signal to the HSPMC 210. In one implementation, the browser application 280 may determine that the user returned to the search result list display or search result display by monitoring user selection of the stack arrow back button 431. The HSPMC 210 may update the search file or corresponding search result file by incrementing a counter that tracks the number of times that the user returned to the search result list display or search result display.

Referring back to FIG. 8, after the search result list display and all of the search result displays associated with the search are closed or otherwise no longer perceivable by the user (e.g., the user exits from the browser application 280), the HSPMC 210 may determine an interest level with respect to each search result based on the search result display interaction data (838). The HSPMC 210 determines an interest level with respect to a search result by processing the user interaction data stored in the corresponding search result file and calculating an interest value for each type of user interaction. The interest level is then determined by multiplying each interest value by a weighting factor and adding up all of the weighted interest values.

The following are examples of how an interest value may be determined for each type of user interaction. These examples are for illustrative purposes only and are not meant to be limiting. The interest values for each type of data may be as follows: e-mail/IM sent interest value=0 (if no e-mails sent) or 1 (if one or more e-mails are sent); saving an image interest value=0 (if no image saved) or 1 (if one or more images are saved); direction of scrolling interest value=0 (if no scrolling direction changes) to 10 (if number of direction changes is substantial); rate of scrolling interest value=0 (if average rate when window is in-focus is either zero or very fast scrolling) to 10 (if average rate when window is in focus is very slow scrolling); link selection in a display interest value=0 (if no links are selected) to x, where x is the number of different links selected up to a maximum of ten; bringing window in and out of focus interest value=0 (if window is kept out-of-focus for most of the time) to 10 (if window is kept in-focus for most of the time), bookmarking an address interest value=0 (if the address of the display is not bookmarked) or 1 (if the address of the display is bookmarked); and returning to a parent display after viewing a child display interest value=0 (if the user never returns to the parent display after viewing a child display) to x, where x is the number of times that the user returns to the parent display after viewing a child display up to a maximum of ten.

Each interest value may be multiplied by a weighting factor. These examples are for illustrative purposes only and are not meant to be limiting. The weighting factor for each type of data may be as follows: e-mail/IM sent interest weighting factor=1000; saving an image weighting factor=500; direction of scrolling weighting factor=50; rate of scrolling weighting factor=50; link selection in a display weighting factor=100; bringing window in and out of focus weighting factor=50; bookmarking an address weighting factor=1000; and returning to a parent display after viewing a child display weighting factor=100.

The interest level with respect to the search result display may be determined by multiplying each interest value with the corresponding weighting factor and adding the results. In the example above, the interest level is a number ranging from 0 to 6000. The resulting interest level may be stored in the corresponding search result file.

After the search result list display and all of the search result displays associated with the search are closed or otherwise no longer perceivable by the user (e.g., the user exits from the browser application 280), the HSPMC 210 may determine an interest level with respect to the search in general based on the search result list display interaction data (840). The HSPMC 210 determines an interest level with respect to the search in general by processing the user interaction data stored in the search file and calculating an interest value for each type of user interaction. The interest level may then be determined by multiplying each interest value by a weighting factor and adding up all of the weighted interest values in the same manner as described above. Using the same interest values and weighting factors as the example above, the interest level with respect to the search in general is a number ranging from 0 to 6000. The resulting interest level may be stored in the corresponding search file.

After determining the interest level with respect to the search in general and determining the interest levels with respect to each search result, the HSPMC 210 may determine the effectiveness of the search based on the determined interest levels (842). The effectiveness of the search may be illustrated by a search effectiveness rating. The search effectiveness rating may be determined, for example, by multiplying the determined interest level with respect to the search in general by a general search weighting factor and multiplying the determined interest levels with respect to the electronic search results by search result weighting factors. The search result weighting factors may vary based on the placement of the identifiers 530 corresponding to the search results in the search result list. For example, the search result weighting factor for an interest level corresponding to an electronic search result that is lower in the search result list may be less than the search result weighting factor for an interest level that is higher in the search result list. The results are then added up to arrive at a search effectiveness rating reflecting the effectiveness of the search. The search effectiveness rating may be normalized for comparison purposes (e.g., the number may be normalized by the number of search results accessed by the user). The search effectiveness rating may be stored in the corresponding search file.

Upon conclusion of process 800, the user profile data store includes a search effectiveness rating for the search, an interest level with respect to the search in general, and interest levels with respect to any search results accessed by the user. As the user performs other searches with different keywords and with other search services, the user profile data store is updated with additional search folders that include search effectiveness ratings, and search and search result interest levels. This information may be processed by the HSPMC 210 or by the browser application 280 to enable a user to access the results in any of a myriad number of ways.

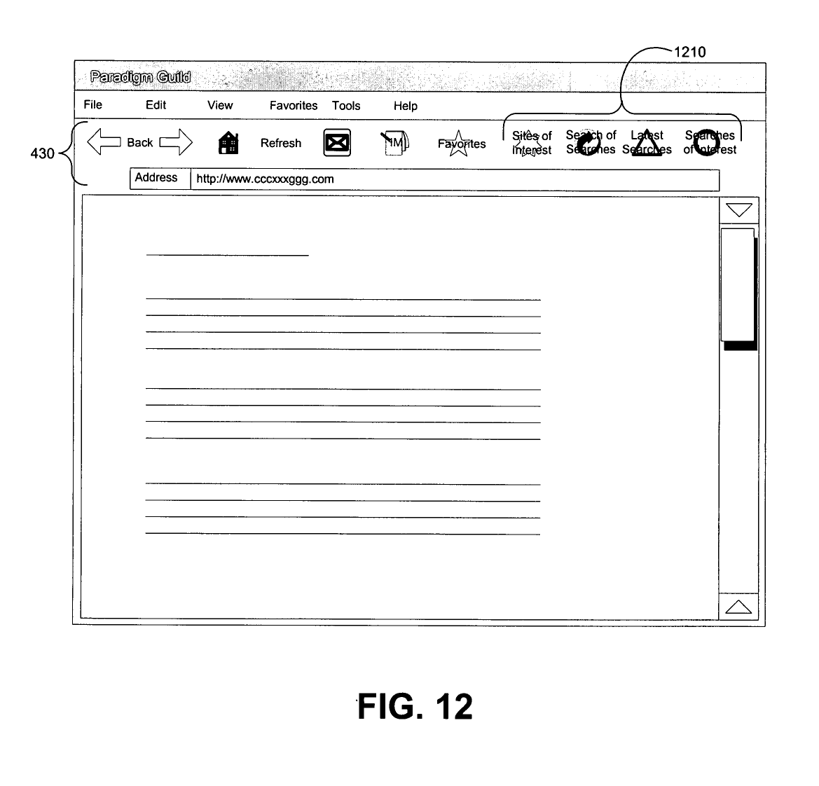

For example, referring to FIG. 12, the user interface 1200 of the browser application 280 may include additional search-related buttons 1210 in the button bar 430. The additional search related buttons may include a “sites of interest” button 1212, a “search of searches” button 1214, a “latest searches” button 1216, and a “searches of interest” button 1218.

The sites of interest button 1212 may be selected by the user to access and perceive a list or grouping of the addresses or web sites of greatest interest to the user. The list or grouping may be generated by the browser application 280 by accessing the search result interest levels in the user profile data store for that user and may rank the addresses or web sites from greatest interest to least interest. For example, selection of button 1212 may result in a list of the ten most interesting sites visited by the user in order of decreasing interest level. The list or grouping may be filtered by other factors including, for example, by time (e.g., a list of the ten most interesting sites visited in the last week, day, month, or year).

The search of searches button 1214 may be selected by the user to perform a search of past searches requested by the user. The search of past searches may be performed as a keyword search in which the user specifies the keywords that should be looked for in or otherwise correspond to the keywords of past searches. The search also may be performed by specifying the time or time interval when the search took place (e.g., yesterday or during the past week). The search of past searches also may enable the user to access and perceive the searches of greatest interest or effectiveness.

The latest searches button 1216 may be selected by the user to access and perceive a listing or grouping of the latest searches requested by the user. The searches of interest button 1214 may be selected by the user to access and perceive a listing or grouping of the searches of greatest interest or of greatest effectiveness.

The HSPMC 210 (or, in another implementation, the client system 205) may enable a search service provider to access the search-related data in the user profile data store. The search-related data may be used by the search service provider as a valuable diagnostic tool to assess the effectiveness of its search services and to improve its search services. For example, by accessing the user profile data store, the search service provider may provide more personalized search results to a given user by organizing or culling search results in accordance with that user's monitored interest levels with respect to similar searches and search results in the past. As another example, the HSPMC 210 may segment the users in accordance with various categories (e.g., by demographics, occupation, interests, hobbies, or any combination thereof) and may make available to the search service provider aggregate search interest-level and search effectiveness information for that segment of users. The search service provider may then improve its search services by organizing or culling search results in accordance with the monitored interest levels with respect to the user segment associated with the user that requested the search.

A number of implementations of the invention have been described. Nevertheless, it will be understood that various modifications may be made. For example, the browser application 280 may be replaced by any front-end search engine application that enables a user to request an electronic search and perceive a search display and/or search result displays. The front-end search engine application passively monitors interactions with the search display and/or search result displays to determine interest levels with respect to the search results and to assess the effectiveness of the search as described above.

Interest levels also may be determined for search result child displays and, optionally, search result grandchild displays. In this implementation, the effectiveness of the search may be determined based on the interest levels of the search in general, the search results, the search result children, and, if applicable, the search result grandchildren. Other more complex implementations may include determination of interest levels with respect to sites even more removed from the search list site and the search result sites.

The above systems and processes also may be more generally applied to determining interest levels with respect to any sites accessed by the browser application 280, not just sites related to a search or search result. Passive monitoring of user interactions with the browser application enables general categorizing of all sites based on interest level.

In another implementation, the user interface 1200 may include additional search related buttons or user interface elements that may be selected by a user to access and display searches based on any of the tracked user interaction data. For example, a button in the user interface 1200 may be selected by a user to list/show all searches that produced at least one search result in which a user highlighted text or that was e-mailed to another user. In another example, a button in the user interface 1200 may be selected by a user to list/show all searches that produced at least two search results that were bookmarked by the user.

In yet another implementation, the user interface 1200 may include additional search related buttons or user interface elements that may be selected by a user to access and display search results based on any of the tracked user interaction data. For example, a button in the user interface 1200 may be selected by a user to list/show all search results in which a user highlighted text or to show all search results that were e-mailed or sent in an instant message to another user. In another example, a button in the user interface 1200 may be selected by a user to list/show all search results that were bookmarked by the user.

Privacy laws may affect the implementation of the above systems and processes. In particular, the HSPMC 210 may send information to the HSSSC 212 or to another system without divulging individual user identities. For example, the HSPMC 210 may use an encrypted user identity or a broad identifier when sending monitored user information to the HSSSC 212 or to another system.

Moreover, the browser application with passive monitoring capability 280 may itself monitor user interactions with the browser application 280 in a manner that does not allow the HSPMC 210 to relate such interactions to a specific individual user identity. Rather, the browser application 280 may encrypt the user's identity and send the encrypted identity along with monitored user interaction data to the HSPMC 210. The HSPMC 210 may thus store the user interaction data under the user's encrypted identity rather than under the user's actual identity, thereby preserving the user's privacy. Alternatively, the browser application 280 may determine the identity of a group/category of users to which the user belongs and may send the group/category identity along with the monitored user interaction data to the HSPMC 210. In this implementation, the HSPMC 210 may determine interest levels and search result effectiveness for anonymous members of a category or group of users.

In yet another implementation, the interest level and search result effectiveness information may be stored locally at the client system 205 rather than at the HSPMC 210. Access to the local storage may be restricted such that an individual user's privacy may be preserved while still allowing use of most of the system's feature including, for example, the “sites of interest”, “search of searches”, “latest searches”, and “searches of interest” features.

Accordingly, other implementations are within the scope of the following claims.

What is claimed is:

1. A method to assess a user's interest level with respect to an electronic search result through passive monitoring of user interaction with a browser application, the method comprising:
determining that a user has requested an electronic search;
enabling the user to perceive one or more identifiers, each identifier corresponding to an electronic search result produced in response to the electronic search request;
enabling the user to select one of the identifiers;
enabling the user to perceive the electronic search result corresponding to the selected identifier through a browser application; and
determining an interest level with respect to the electronic search result corresponding to the selected identifier by passively monitoring the user's interactions with the browser application while the user perceives the electronic search result corresponding to the selected identifier.

2. The method of claim 1, wherein determining that a user has requested an electronic search includes monitoring an address field associated with contents displayed by the browser application.

3. The method of claim 2, wherein monitoring the address field comprises monitoring the address field to determine whether the address in the address field corresponds to a search service provider.

4. The method of claim 1, wherein determining that a user has requested an electronic search includes monitoring requests for information delivered by the browser application in response to user manipulation.

5. The method of claim 4, wherein monitoring requests for information comprises monitoring requests for information to determine whether the requests for information include a request for a search delivered to a search service provider.

6. The method of claim 1, wherein enabling the user to perceive one or more identifiers comprises enabling the user to perceive a group of one or more hyperlinks selectable by the user to access electronic search results.

7. The method of claim 1, wherein the browser application is a specialized program to display, access, and process information.

8. The method of claim 7, wherein the browser application is a specialized program to display, access, and process Internet content.

9. The method of claim 1, wherein determining an interest level with respect to the electronic search result by passively monitoring user interactions with the browser application includes monitoring the user interactions with the browser application to render, process, and access content without requiring active user input related to monitoring.

10. The method of claim 1, wherein determining an interest level with respect to the electronic search result by passively monitoring user interactions with the browser application includes passively monitoring the user selecting to send content displayed by the browser application in an e-mail message or in an instant message.

11. The method of claim 1, wherein determining an interest level with respect to the electronic search result by passively monitoring user interactions with the browser application includes passively monitoring the user highlighting or copying text displayed by the browser application.

12. The method of claim 1, wherein determining an interest level with respect to the electronic search result by passively monitoring user interactions with the browser application includes passively monitoring the user saving an image displayed by the browser application.

13. The method of claim 1, wherein determining an interest level with respect to the electronic search result by passively monitoring user interactions with the browser application includes passively monitoring the direction and rate of scrolling by the user when using scroll bars in a user interface of the browser application.

14. The method of claim 1, wherein determining an interest level with respect to the electronic search result by passively monitoring user interactions with the browser application includes passively monitoring the user selecting one or more links displayed by the browser application.

15. The method of claim 1, wherein determining an interest level with respect to the electronic search result by passively monitoring user interactions with the browser application includes passively monitoring the user bringing a user interface of the browser application into focus.

16. The method of claim 15, wherein the user interface is a window and bringing a user interface of the browser application into focus comprises selecting the user interface so that the user interface window is placed on top of all other windows in a visually displayed desktop.

17. The method of claim 1, wherein determining an interest level with respect to the electronic search result by passively monitoring user interactions with the browser application includes passively monitoring the user selecting to bookmark an address associated with the electronic search result.

18. The method of claim 1, wherein:
the user perceives the electronic search result in an electronic search result display, and
determining an interest level with respect to the electronic search result by passively monitoring user interactions with the browser application includes passively monitoring the user returning to perceive the electronic search result display after perceiving a display presented in response to selection of a link included in the electronic search result display.

19. The method of claim 1, wherein determining an interest level with respect to the electronic search result by passively monitoring user interactions with the browser application includes assigning a weighting factor to each type of passively monitored user interaction, determining an interest value indicative of the level of user interaction with respect to each type of user interaction, using the weighting factors to weight the corresponding determined interest values for each type of user interaction, and combining the weighted interest values to arrive at an aggregate interest level number.

20. The method of claim 19, wherein higher weighting factors are assigned to types of user interactions deemed to correspond to greater user interest in the electronic search result.

21. A computer system for assessing a user's interest level with respect to an electronic search result through passive monitoring of user interaction with a browser application, the computer system comprising:
a search request monitoring element configured to determine that a user has requested an electronic search;
a display element configured to
enable the user to perceive one or more identifiers, each identifier corresponding to an electronic search result produced in response to the electronic search request;
enabling the user to select one of the identifiers; and
enable the user to perceive the electronic search result corresponding to the selected identifier through a browser application; and
an interest level processing element configured to determine an interest level with respect to the electronic search result corresponding to the selected identifier by passively monitoring the user's interactions with the browser application while the user perceives the electronic search result corresponding to the selected identifier.

22. A method to assess the effectiveness of an electronic search through passive monitoring of user interaction with a browser application, the method comprising:
determining that a user has requested an electronic search;
enabling the user to perceive through a browser application a display of one or more identifiers, each identifier corresponding to an electronic search result produced in response to the electronic search request; and
determining the effectiveness of the requested electronic search by passively monitoring the user's interactions with the browser application while the user perceives content related to the electronic search.

23. The method of claim 22, wherein content related to the electronic search includes the content in the display and content related to the electronic search results.

24. The method of claim 22, wherein determining the effectiveness of the electronic search includes:
enabling the user to select one or more of the identifiers;
enabling the user to perceive the electronic search results corresponding to the selected one or more identifiers through a browser application;
determining interest levels with respect to the electronic search results corresponding to the selected one or more identifiers by passively monitoring the user's interactions with the browser application while the user perceives the one or more electronic search results; and
determining the effectiveness of the search based on the determined search result interest levels.

25. The method of claim 24, wherein determining the effectiveness of the electronic search further includes:
determining an interest level with respect to the search by passively monitoring the user's interactions with the browser application while the user perceives the display; and
determining the effectiveness of the search based on the determined search interest level and search result interest levels.

26. The method of claim 25, wherein determining the effectiveness of the search based on the determine search interest level and search result interest levels includes assigning weighting factors to the search and search result interest levels, using the weighting factors to weight the interest levels, and combining the weighted interest levels to arrive at a search effectiveness rating.

27. The method of claim 26, wherein higher weighting factors are assigned to search result interest levels corresponding to search results placed higher in a list of search results presented in the display.

28. A computer system for assessing the effectiveness of an electronic search through passive monitoring of user interaction with a browser application, the computer system comprising:
a search request monitoring element configured to determine that a user has requested an electronic search;
a display element configured enable the user to perceive through a browser application a display of one or more identifiers, each identifier corresponding to an electronic search result produced in response to the electronic search request; and
a search effectiveness processing element configured to determine the effectiveness of the requested electronic search by passively monitoring the user's interactions with the browser application while the user perceives content related to the electronic search.
